(19) United States
(12) Patent Application Publication
(10) Pub. No.: US 2021/0085068 A1
(43) Pub. Date: Mar. 25, 2021

(54) GUIDED ROUTINES FOR SMART PERSONAL CARE DEVICES

(71) Applicant: L'Oreal, Paris (FR)

(72) Inventors: Jeffrey Kissinger, Kirkland, WA (US); Zane Bowman Allen Miller, Seattle, WA (US); Geoffrey Deane, Redmond, WA (US)

(73) Assignee: L'Oreal, Paris (FR)

(21) Appl. No.: 16/576,625

(22) Filed: Sep. 19, 2019

(51) Int. Cl. A46B 15/00; A45D 44/00; G06F 3/16; G06F 9/451

(52) U.S. Cl. CPC A46B 15/0004; A45D 44/00; A45D 2044/007; G06F 9/453; A46B 2200/104; G06F 3/16

(57) ABSTRACT

A personal care device comprises at least one treatment application unit configured to apply a treatment to user; a human-machine interface (HMI) comprising a speaker; and a personal care unit operably coupled to the HMI and to the at least one treatment application unit. The personal care unit includes circuitry for presenting voice cues via the HMI in a computer-guided care routine to guide user operation of the personal care device, and circuitry for controlling the at least one treatment application unit. In an embodiment, the circuitry for presenting voice cues via the HMI includes circuitry for generating a random selection from a set of voice cues stored in memory and/or computational circuitry including one or more processors operably connected to a speaker and configured to enable one or voice cues via the HMI that sequence in concert with a computer-guided care routine stored in memory.

### SUMMARY

In one aspect of the present disclosure, a personal care device comprises at least one treatment application unit configured to apply a treatment to user; a human-machine interface (HMI) comprising a speaker; and a personal care unit operably coupled to the HMI and to the at least one treatment application unit, the personal care unit including circuitry for presenting voice cues via the HMI in a computer-guided care routine to guide user operation of a personal care device, and circuitry for controlling the at least one treatment application unit. In an embodiment, the circuitry for presenting voice cues via the HMI includes circuitry for generating a random selection from a set of voice cues stored in memory. The random selection may be from among a set of possible voice cues that are appropriate for a corresponding stage in a care routine. In an embodiment, the circuitry for presenting voice cues via the HMI includes computational circuitry including one or more processors operably connected to a speaker and configured to enable one or voice cues via the HMI that sequence in concert with a computer-guided care routine stored in memory.

In an embodiment, the personal care device further comprises a network interface; circuitry for receiving signals from a networked computing device (e.g., a server or a client computing device, such as a smart speaker in communication with an external voice services system) via the network interface; and circuitry for transmitting signals to the networked computing device via the network interface. In an embodiment, the signals received from the networked computing device comprise the voice cues.

In an embodiment, the personal care device further comprises a microphone and circuitry for processing audio input received via the microphone.

In an embodiment, the personal care device comprises a hair dryer, a hair styling iron, a phototherapy device, or a powered skincare device. In an embodiment, the personal care device comprises a powered skin brush, and wherein the treatment application device comprises a brush head.

In another aspect, a computer-implemented method comprises selecting voice cues from a plurality of available voice cues to guide user operation of a personal care device in a computer-guided care routine, wherein the selected voice cues are to be output via a speaker during the computer-guided care routine; and causing the selected voice cues to be output via the speaker during the computer-guided care routine.

In an embodiment, selecting voice cues from the plurality of available voice cues to guide user operation of the personal care device in the computer-guided care routine includes activating a networked computing device in communication with the personal care device to generate one or more voice cues via the HMI that sequence in concert with a computer-guided care routine stored in memory, or automatically activating one or more voice cues stored at least on a memory device forming part of the personal care device responsive to receiving one or more inputs indicative of a computer-guided care routine.

In an embodiment, causing the selected voice cues to be output includes transmitting instructions to output the selected voice cues from a networked computing device to the personal care device.

In another aspect, a computer-implemented method comprises, by a server computer, generating or modifying a computer-guided care routine for a personal care device; selecting voice cues from a plurality of available voice cues for guiding user operation of the personal care device in the computer-guided care routine, wherein the personal care device comprises a speaker, and wherein the voice cues are to be output via the speaker during the computer-guided care routine; and transmitting the selected voice cues directly or indirectly to the personal care device or to a client computing device in communication with the personal care device. In an embodiment, generating or modifying the computer-guided care routine is based on one or more criteria comprising characteristics of the personal care device, previous outcomes, user preferences or behaviors, time of day, environmental conditions, day of week, day of year, or a combination thereof.

Any of the described embodiments may include selecting voice cues for each of a plurality of stages associated with a computer-guided care routine. Any of the described embodiments may include selecting voice cues based on one or more selection criteria comprising characteristics of the personal care device, previous outcomes, user preferences or behaviors, time of day, environmental conditions, day of week, day of year, or a combination thereof.

Further embodiments include illustrative computing devices, computer systems, and computer-readable media.

Any of the embodiments described herein may be implemented, independently or in any combination, as a feature of a digital personal care marketplace or platform.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B are schematic diagrams that provide a high-level overview of embodiments of a computer system that includes a personal care device according to various aspects of the present disclosure;

FIG. 2 is a block diagram that illustrates an example embodiment of a client computing device according to various aspects of the present disclosure;

FIG. 3 is a block diagram that illustrates components included in an example embodiment of a personal care device according to various aspects of the present disclosure;

FIG. 4 is a flowchart that illustrates an example embodiment of a method of selecting voice cues to guide operation of a personal care device in a computer-guided care routine according to various aspects of the present disclosure;

FIG. 5 is a flowchart that illustrates an example embodiment of a method of generating or modifying a computer-guided care routine and selecting voice cues to guide operation of a personal care device in the computer-guided care routine according to various aspects of the present disclosure;

FIG. 6 is a block diagram that illustrates aspects of an exemplary computing device appropriate for use with embodiments of the present disclosure.

### DETAILED DESCRIPTION

E-commerce platforms and social networking platforms are well known features of today's technological world. Such platforms are useful for sharing information about products, including personal care products and related care routines, which can be helpful to consumers that wish to learn how to improve their personal care routines or to get more benefits from their products. However, current platforms include many unsolved technical problems.

For example, although personal care products and devices of all types may be purchased on the Internet, the task of learning how to use such products or devices effectively is largely left up to the consumer herself, using known tools such as Internet search engines. Although consumers may use search engines to find relevant information about how personal care devices may be used by others, or what the capabilities of those devices are, consumers are often unable to configure or use those devices in optimal ways based on such information. Furthermore, as personal care devices become more complex, and include more programmable and Internet-connected features, the act of configuring and using such devices also becomes more complex, especially for ordinary consumers. This leaves consumers unable to benefit from all the ways their devices could be configured and used.

Embodiments described herein provide technical solutions to one or more of the technical problems described above, or other technical problems.

In an embodiment, a computer system facilitates adjustments of settings or programmed routines of personal care devices to, e.g., improve the effectiveness of the device or enhance the consumer's experience with the device. A wide variety of operational parameters may be adjusted in personal care devices. Such parameters may be set in particular ways to benefit a particular consumer during programmed or guided care routines. For example, adjustable parameters for powered skin brushes may include adjustable power settings, timers, speed settings (e.g., rotation or oscillation speed for a brush head), haptic feedback parameters, or other parameters or combinations of parameters. Other parameters may be adjusted for different personal care devices. For example, hair dryer devices may include adjustable temperature and airflow parameters.

Described embodiment provided clear guidance to users to promote improved performance of care devices or enhanced user experiences. In described embodiments, a smart personal care device guides a user through a pre-defined or dynamically updated cleansing routine using sound cues (e.g., synthesized or recorded voice cues). The smart personal care device determines cues to present to the user based on one or more selection criteria (e.g., characteristics of the personal care device such as available settings or attachments, previous outcomes, user preferences or behaviors, time of day, environmental conditions (e.g., temperature, humidity, pollution, UV levels, etc.), current month/season of the year, day of the week, or the like). In an embodiment, the smart personal care device provides audio cues to users. Audio cues may be replaced by or used in combination with haptic cues, which may be used to provide different feedback to guide the user through a routine. In such embodiments, the smart personal care device may include haptic electronics such as tactile sensors or vibrating actuators. The guided care routine functionality of smart personal care device may be activated in various ways, such as by a hardware button press (e.g., an on/off switch or a dedicated button for activating a care routine), by a voice command, or in some other way.

Described embodiments include several different configurations for providing cues to users. In an embodiment, a smart personal care device includes audio electronics and a corresponding output device, such as a speaker or headphone jack, digital storage to store information corresponding to the audio cues (e.g., recorded audio cues or instructions for synthesizing such cues), and a microcontroller programmed to provide a voice interface by selecting cues to play during a care routine. In an embodiment, cues are selected to guide a user through different stages of the care routine, such as moving a skin care device to different skin areas, changing speeds, changing cleansing modes, and the like. One or more voice cues are available for selection at different stages of the care routine.

In an embodiment, multiple voice cues are available for each of a plurality of stages in a care routine. In an illustrative scenario, in order to prepare a user to move the brush head of a skin cleansing device from a forehead area to an eye area, different cues such as “let's move to the eyes”; “time to work on your eyes,” and “get ready to move the brush head from your forehead to your eyes” are available for selection. The selected cue may then be followed by a related cue, such as “reduce your brush head speed now” or “remember to go easy on your eyes with lighter pressure.” Selection of cues for a care routine can be performed in different ways. For example, the selection of a particular cue within an available set may be performed at random, based on user preferences, on a rotating basis, or in some other way. Variations in cues can help to keep the user's experience fresh and keep the user engaged in the routine. In an embodiment, cues are personalized with a user's name or in other ways. In an embodiment, voice cues may include cues that are not specifically related to the care routine, such as a “happy birthday” announcement on the user's birthday. In an embodiment, cues are presented in different languages based on, e.g., user preference or location. In an embodiment, machine learning techniques are used to select more effective cues to use for a particular user or class of users.

In an embodiment, a smart personal care device further includes wireless communication circuitry, such as a wireless transceiver for Wi-Fi communication. In such an embodiment, the smart personal care device may access a voice-interface service via wireless communication circuitry from a remote computer system. In another embodiment, the smart personal care device further includes Bluetooth or near-field communication

(NFC) circuitry, either in place of or in addition to Wi-Fi communication circuitry. In such an embodiment, the smart personal care device may communicate with an external client computing device, such as a smart phone or tablet computer, which may in turn access a voice-interface service via its own communication circuitry from a remote computer system. In another embodiment, the smart personal care device includes circuitry for communicating with a smart speaker, such as an Amazon Echo or Google Home device, which may include its own voice-interface service or communicate with a remote computer system to access voice-interface services.

In an embodiment, a smart personal care device includes sensors for detecting the position, orientation, or physical environment (e.g., humidity, temperature, ambient light levels, etc.) of the device during a care routine. The information generated by such sensors can be used by the device (or computer systems that may be in communication with the device) in order to help guide the user through the routine or to make adjustments for better results. For example, a smart skin cleansing device may include sensors to detect the position or angle of a handle or brush head. In an illustrative scenario, such information is used to determine, e.g., an appropriate voice cue or other guidance for the user, such as a cue to adjust the angle of the handle where sensor information (e.g., from an accelerometer or gyroscope on the device) indicates that the device is being held incorrectly.

In an embodiment, recommendations and content may be personalized for the consumer based on contextual information such as consumer preferences, environmental factors, and the like. Consumers can use profiles to store system preferences, social network account or contact information, product/service provider ratings or preferences, location information, questionnaire answers, information from connected devices (e.g., smart care devices such as hair dryers, powered skin brushes, or the like), or other information.

Information obtained from devices may be used to guide custom product or care routine selections, or for other purposes. Such information may include device identification information, configuration information, usage information (e.g., how often a device is used, duration of use, time of day, etc.), sensor information (e.g., measurements of environmental conditions such as temperature, humidity, pollution levels, UV radiation levels, etc., or skin conditions such as pH levels), location information, combinations of such information, or other information. Sensor information may be provided via sensor-enabled or connected Internet-of-Things (IoT) devices. Such devices may include smart mirrors, sensor-enabled hair-brushes or other personal care devices, mobile computing devices, and the like.

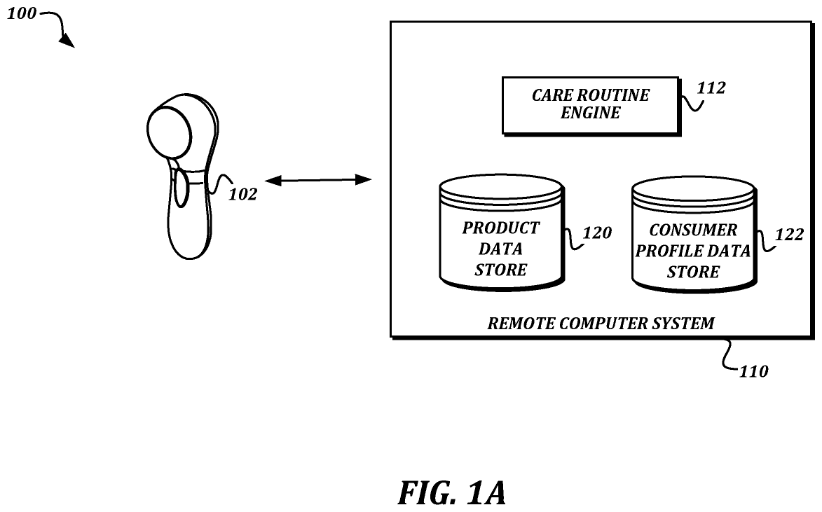

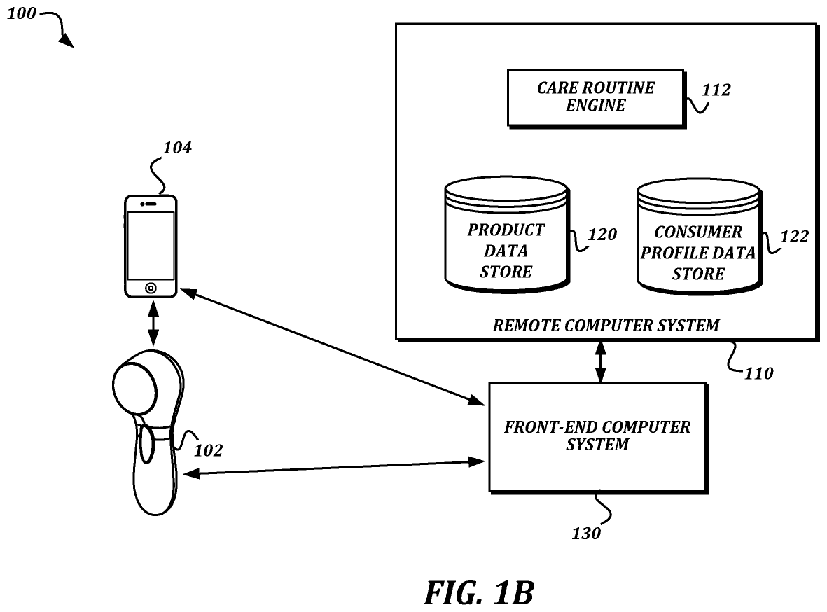

FIG. 1A is a block diagram that illustrates a generalized example embodiment of a system according to various aspects of the present disclosure that help solve one or more of the problems described above, while also providing technical benefits described in more detail below. As shown in FIG. 1A, the system 100 includes a personal care device 102 (in this example, a powered skin brush) with wireless communication circuitry. The personal care device 102 is in communication with a remote computer system 110, either directly or via one or more intermediary computing devices and network hardware (not shown). In an embodiment, the remote computer system 110 includes functionality for remote configuration of the personal care device 102, to provide a set of cues to guide a personal care routine, or to update an existing set of cues. Details of such embodiments, and other embodiments, are described in further detail below.

The personal care device 102 may send information (e.g., usage data, device identification/configuration data, or the like) to the remote computer system 110, which may use this information to generate custom content for the consumer, such as custom care routines, product recommendations, or settings or parameters for operation of the personal care device 102. For example, a custom care routine for a skin cleansing device may include a defined pattern of skin areas to be cleansed during the routine, time durations for each skin area, and brush head speeds or cleansing modes for each skin area. In an embodiment, a selection of voice cues is available for selection for each stage. In an embodiment, custom care routine definitions, device settings, or care routine cues are uploaded to the personal care device 102. The illustrative components of the remote computer system 110 are described in detail below.

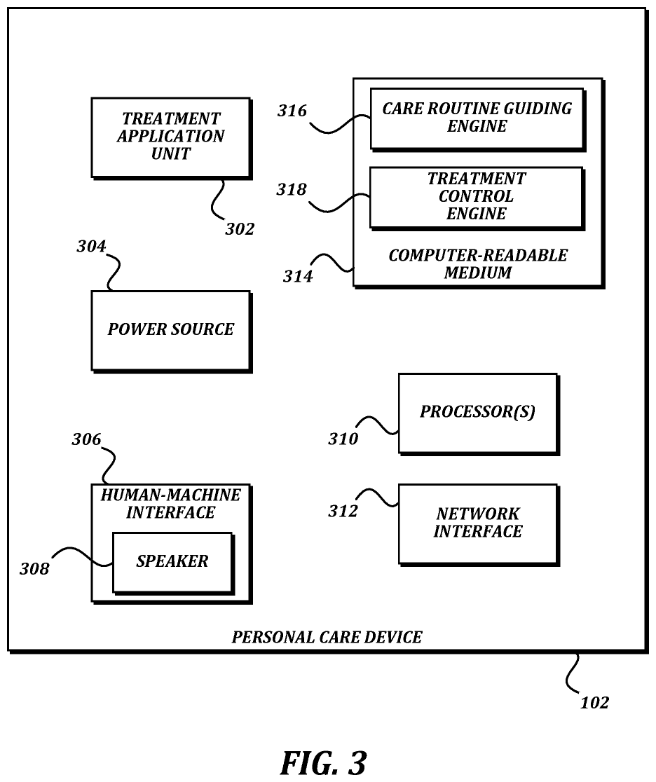

The personal care device 102 may include devices such as smart skin care device (e.g., a powered skin brush or massager with computer-controlled elements and data transmission/receiving capability), or a smart hair care device (e.g., a hair brush with humidity or temperature sensors and data transmission capability, a hair dryer with computer-controlled airflow and temperature elements and data transmission/receiving capability). Illustrative features of a personal care device 102 are described below with reference to FIG. 3. Personal care devices 102 may also include or communicate with environmental sensors and/or other computing devices.

FIG. 1B is a block diagram that illustrates another example embodiment of a system according to various aspects of the present disclosure that help solve one or more of the problems described above, while also providing technical benefits described in more detail below. In the illustrative usage scenario depicted in FIG. 1B, a consumer uses a client computing device 104 to connect to a web interface of the front-end computer system 130. The front-end computer system 130 may send information to the remote computer system 110, which may use this information to generate custom content for the consumer, such as custom care routines, product recommendations, or settings or parameters for operation of the personal care device 102, as described in further detail below. In an embodiment, custom routines or device settings may be uploaded to the client computing device 104 for subsequent transmission to the personal care device 102.

The client computing device 104 may be used by a consumer to interact with other components of the system 100, such as the front-end computer system 130 or personal care devices 102. In an embodiment, the client computing device 104 is a mobile computing device such as a smart phone or a tablet computing device. However, any other suitable type of computing device capable of communicating via the network and presenting a user interface, including but not limited to a desktop computing device, a laptop computing device, a smart speaker, or a smart watch (or combinations of such devices) may be used.

The front-end computer system 130 includes one or more server computers that provide an interface for client computing devices 104 to access functionality of the remote computer system 110. In an embodiment, the front-end computer system 130 provides a web interface through which an end user may access such functionality, e.g., via a web browser or a dedicated client application.

Illustrative components and functionality of the remote computer system 110, as shown in FIGS. 1A and 1B, will now be described. The remote computer system 110 includes one or more server computers that implement the illustrated components, e.g., in a cloud computing arrangement. As illustrated in FIGS. 1A and 1B, the remote computer system 110 includes a care routine engine 112, a product data store 120, and a consumer profile data store 122. The care routine engine 112 generates guided care routine information, which can then be transmitted to the personal care device 102. The guided care routine information may include, for example, programmatic care routine instructions, voice cues, product recommendations, or other information.

In an embodiment, the care routine engine 112 generates guided care routine information based on information received from the product data store 120 along with consumer information from the consumer profile data store 122, the personal care device 102, the client computing device 104, or from some other source. The care routine engine 112 may, for example, receive a request for an updated care routine from the personal care device 102 or the client computing device 104, obtain information from the product data store 120 (e.g., available settings and configurations for the personal care device 102, available attachments, etc.), the consumer profile data store 122 (e.g., consumers' answers to questions about themselves, device usage data, preferred care routines, location, age, products used, etc.), or the client computing device 104 (e.g., information describing the consumer's current location, satisfaction with previous routines (indicated by e.g., star rating or number rating), current mood/stress level, etc.), and use this information to perform further processing. For example, the care routine engine 112 may use the information it obtains to select from among available previously defined routines to match the user's current stress level and time of day (e.g., by selecting a gentle skin cleansing or massage routine at night, where the user has indicated a high level of stress), generate a new routine, update a previously defined routine, or generate or revise care routine cues, such as updating voice cues to match the steps of a revised care routine. In an embodiment where a client computing device 104 is present (see FIG. 1B), the care routine engine 112 may provide information on recommended products (e.g., cleansers, device attachments, etc.), tutorials on how to use the personal care device 102 or any recommended products, or the like.

The care routine engine 112 may employ machine learning or artificial intelligence techniques (e.g., template matching, feature extraction and matching, classification, artificial neural networks, deep learning architectures, genetic algorithms, or the like) to, for example, generate or revise care routines, care routine cues, product recommendations, or other content. In an embodiment, machine learning techniques are used to analyze a user's routine and determine, for example, whether routines are not being followed by the user in an optimal way (e.g., wrong cleansing product being used, too little time spent on a routine or on a particular part of a routine, routines not being fully completed, adjustments needed based on environmental factors or time of day, etc.) or whether other voice cues or other ways of presenting cues (e.g., male/female voices, lower or higher volume, etc.) may be more effective. In an embodiment, data regarding the consumer or the consumer's routine is compared with other consumers; results of those comparisons may be provided to the consumer for educational purposes, or stored and analyzed for research purposes (e.g., to improve manufacturer's knowledge of consumer preferences or inter-product compatibility).

In an embodiment, to further improve or enhance a care routine, additional technical or clinical information relating to the consumer is used. For example, to generate a custom care routine, the care routine engine 112 may obtain technical analysis of images of the consumer to measure or map wrinkles, pigmentation, skin texture, etc., of the consumer's skin. In such a scenario, the care routine engine 112 may use such information to recommend a particular care routine that suits the particular features of the consumer's skin.

In an embodiment, location information obtained by a personal care device or a client computing device may be used to look up and obtain other information from other computing devices or systems, which may be relevant to a care routine. For example, a client computing device 104 may provide location information to a remote computer system 110, which may in turn obtain current weather or pollution information for the respective location. The remote computer system 110 may then use the current weather or pollution information to generate or modify a care routine, or to generate or select care routine cues. In an illustrative scenario, the remote computer system 110 uses location information to determine that the user is in a hot, polluted city; generates or modifies a care routine to account for this environment; and selects appropriate voice cues to guide the user through the care routine, such as suggesting an appropriate skin care treatment. In an embodiment, voice cues or care routines may further depend on time of day information. In an illustrative scenario, the remote computer system 110 uses time of day information to determine that the care routine will take place in the morning, and selects voice cues including reminders to apply sunblock or remain well hydrated throughout the day.

In an embodiment, information is stored, transmitted, and shared within the system 100 in a secure and reliable manner. For example, secure connections are established between client computing devices and personal care devices, between client computing devices and server systems, between front-end and back-end systems, between back-end systems and manufacturing or fulfillment systems, or any other set of communicating devices. Consumers may be securely reminded of care routine events, environment alerts (e.g., temperature, humidity, pollution, or UV radiation warnings), product expirations, and the like via push notifications to a client application, email, instant messaging, or some other communication channel.

The devices shown in FIGS. 1A and 1B may communicate with each other via a network (not shown), which may include any suitable communication technology including but not limited to wired technologies such as DSL, Ethernet, fiber optic, USB, and Firewire; wireless technologies such as WiFi, WiMAX, 3G, 4G, LTE, 5G, and Bluetooth; and the Internet. In general, communication between the components of the systems in FIGS. 1A and 1B or other computing devices may occur directly or through intermediate devices. Many alternatives to the arrangement disclosed and described with reference to FIGS. 1A and 1B are possible. For example, functionality described as being implemented in multiple components may instead be consolidated into a single component, or functionality described as being implemented in a single component may be implemented in multiple illustrated components, or in other components that are not shown in FIGS. 1A and 1B.

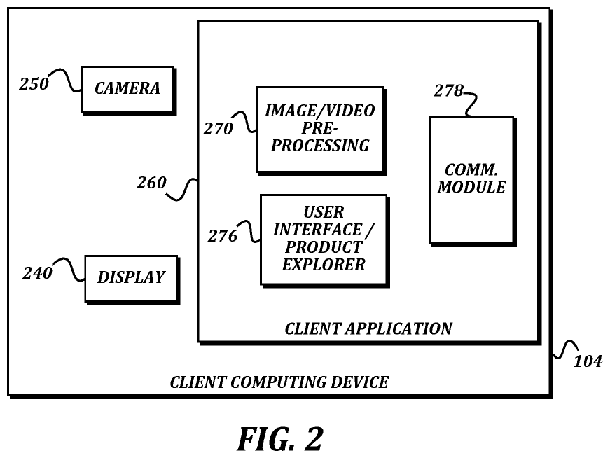

FIG. 2 is a block diagram that illustrates an example embodiment of a client computing device 104 according to various aspects of the present disclosure. FIG. 2 depicts a non-limiting example of client computing device features and configurations; many other features and configurations are possible within the scope of the present disclosure.

In the example shown in FIG. 2, the client computing device 104 includes a camera 250 and a client application 260. The client application 260 includes a user interface 276, which may include interactive functionality such as guides, tutorials, virtual “try-on” functionality, or product exploration technology, which may be presented on a display 240, such as a touchscreen display. Customized content may be obtained by the client computing device 104 (e.g., from the front-end computer system 130) and provided to the consumer via the user interface 276 in the form of product recommendations, tutorial videos, computer animations, simulations, or other user experiences.

In an embodiment, a communication module 278 of the client application 260 is used to prepare information for transmission to, or to receive and interpret information from other devices or systems, such as the front-end computer system 130 or a personal care device 102. Such information may include personal care device settings, custom care routines, consumer preferences, user identifiers, device identifiers, or the like

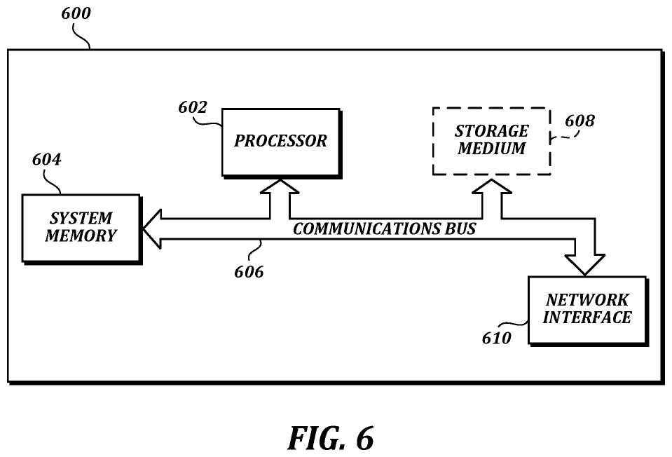

In an embodiment, the client application 260, user interface 276, or related technology also may be provided via a client computing device at a salon, spa, retail store, or the like. Other features of client computing devices are not shown in FIG. 2 for ease of illustration. A description of illustrative computing devices is provided below with reference to FIG. 6.

FIG. 3 is a block diagram that illustrates components included in an example embodiment of a personal care device according to various aspects of the present disclosure. FIG. 3 depicts a non-limiting example of personal care device features and configurations; many other features and configurations are possible within the scope of the present disclosure.

In the example shown in FIG. 3, the personal care device 102 includes a treatment application unit 302 configured to apply a treatment to a user, a power source 304, a human-machine interface device 306, a processor 310, a network interface 312, and a computer-readable medium 314. One non-limiting example of a personal care device 102 is a powered facial cleansing brush with a brush head that oscillates, rotates, or otherwise moves in order to perform a scrubbing action. Other non-limiting examples of personal care devices 102 include a massaging device, a handheld light-emitting device that may be used to expose skin to light to achieve therapeutic benefits, a phototherapy device with adjustable wavelength settings, a hair styling iron with adjustable temperature settings, or a hair dryer with adjustable airflow and temperature settings.

In an embodiment, the treatment application unit 302 includes one or more devices that collectively apply a treatment to a consumer. For example, if the personal care device 102 is a powered skin brush, the treatment application unit 302 may include a drive motor, an armature coupled to the drive motor that accepts a detachable brush head, and the brush head itself. As another example, if the personal care device 102 is a handheld light-emitting device, the treatment application unit 302 may include one or more light-emitting diodes (LEDs), lasers, or other light-emitting devices.

In an embodiment, the power source 304 is a rechargeable battery that provides power to the treatment application unit 302 for operation. The power source 304 also may also provide power for operation to the other components of the personal care device 102. In other embodiments, instead of a battery, the personal care device 102 may be coupled to an external power source, such as an electrical outlet.

The human-machine interface (HMI) 306 may include any type of device capable of receiving user input or generating output for presentation to a user. In an embodiment, the HMI 306 includes a speaker 308 to allow the personal care device 102 to present audio content (e.g., care-routine cues in the form of synthesized or recorded speech, tones, etc.) and/or a microphone receive audio input, such as voice commands from a user. In addition to voice cues, the speaker 308 may present other output to accompany the care routine such as music, calming nature sounds, or the like. Other non-limiting examples of possible components of the HMI 306 include a push-button switch, a toggle switch, a capacitive switch, a rotary switch, a slide switch, a rocker switch, and a touch screen.

The processor 310 is configured to execute computer-executable instructions stored on the computer-readable medium 314. In an embodiment, the processor 310 is configured to receive and transmit signals to and/or from other components of the personal care device 102 via a communication bus or other circuitry. The network interface 312 is configured to transmit and receive signals to and from the client computing device 104 (or other computing devices) on behalf of the processor 310. The network interface 312 may implement any suitable communication technology, including but not limited to short-range wireless technologies such as Bluetooth, infrared, near-field communication, and Wi-Fi; long-range wireless technologies such as WiMAX, 2G, 3G, 4G, LTE, and 5G; and wired technologies such as USB, FireWire, and Ethernet. The computer-readable medium 314 is any type of computer-readable medium on which computer-executable instructions may be stored, including but not limited to a flash memory, a ROM, an EPROM, an EEPROM, and an FPGA. The computer-readable medium 314 and the processor 310 may be combined into a single device, such as an ASIC, or the computer-readable medium 314 may include a cache memory, a register, or another component of the processor 310.

In the illustrated embodiment, the computer-readable medium 314 has computer-executable instructions stored thereon that, in response to execution by one or more processors 310, cause the personal care device 102 to provide a care routine guiding engine 316 and a treatment control engine 318. The treatment control engine 318 controls one or more aspects of the personal care device 102 in a care routine, as described above. In an embodiment, the care routine is generated and/or modified by the care routine engine 112, as described above. In an embodiment, the treatment control engine 318 adjusts settings or configurations for the personal care device 102, which may be generated and/or modified by the care routine engine 312, as described above. In an embodiment, the care routine guiding engine 316 controls presentation of care routine cues, such as by causing audio cues to be output by the speaker 308 in order to guide a consumer's actions during a care routine. Care routine cues presented in this way may be generated and/or modified by the care routine engine 112, as described above. In an embodiment, the care routine guiding engine 316 collects data such as data describing execution of care routines, environmental data, usage data, or other data. The care routine guiding engine 316 stores this data in the computer-readable medium 314. In an embodiment, this data is subsequently transmitted via the network interface 312 to the remote computer system 110 (e.g., via the client computing device 104 or directly) for storage (e.g., in the product data store 120 or consumer profile data store 122) or for further processing by the care routine engine 112 (e.g., updating a care routine or care routine cues, adjusting personal care device settings, etc.). In an embodiment, such updates are based at least in part on factors represented in the data, such as environmental data, usage data, or a consumer's preferences or ability to follow a particular care routine.

In an embodiment, the treatment control engine 318 controls basic functions such as turning the treatment application unit on or off. In such an embodiment, the treatment control engine 318 detects actuation of the HMI 306, and activates the treatment application unit 302 in response. The treatment control engine 318 may then detect a subsequent actuation of the HMI 306 and deactivate the treatment application unit 302 in response, or may allow the treatment application unit 302 to operate for a predetermined amount of time before automatically deactivating the treatment application unit 302.

In an embodiment, the processor(s) 310 and the computer-readable medium 314, which may include the engines 316 and 318, provide circuitry that may be collectively referred to as a personal care unit of the personal care device 102. In an embodiment, the personal care unit is operably coupled to the HMI 306 and to the treatment application unit 302, and the personal care unit includes circuitry for presenting voice cues via the HMI in a computer-guided care routine to guide user operation of a personal care device, and circuitry for controlling the treatment application unit 302. Alternatively, the personal care device 102 may include different circuitry, or the circuitry may be implemented in some other way.

In an embodiment, to allow for use in moist environments such as a bath or shower, components of the personal care device 102 (e.g., the speaker 108 or other components of the components of the HMI device 306) may be waterproof or water resistant.

Within components of the system 100, or by components of the system 100 working in combination, numerous technical benefits are achieved. For example, the ability to automatically generate or modify care routines, or cues to guide consumers in implementing such routines, overcomes technical limitations of prior technologies, such as search engines, as described above. As another example, the ability to remotely configure personal care devices overcomes technical limitations of prior technologies that depended on consumer's abilities to configure their own devices and did not allow for remote configuration of such devices. As another example, the system 100 allows some aspects of the process to be conducted independently by personal care devices or client computing devices, while moving other processing burdens to the remote computer system 110 (which may be a relatively high-powered and reliable computing system), thus improving performance and preserving battery life for functionality provided by personal care devices or client computing devices.

In general, the word “engine,” as used herein, refers to logic embodied in hardware or software instructions written in a programming language, such as C, C++, COBOL, JAVA™, PHP, Perl, HTML, CSS, JavaScript, VBScript, ASPX, Microsoft .NET™, and/or the like. An engine may be compiled into executable programs or written in interpreted programming languages. Software engines may be callable from other engines or from themselves. Generally, the engines described herein refer to logical modules that can be merged with other engines or divided into sub-engines. The engines can be stored in any type of computer-readable medium or computer storage device and be stored on and executed by one or more general purpose computers, thus creating a special purpose computer configured to provide the engine or the functionality thereof.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

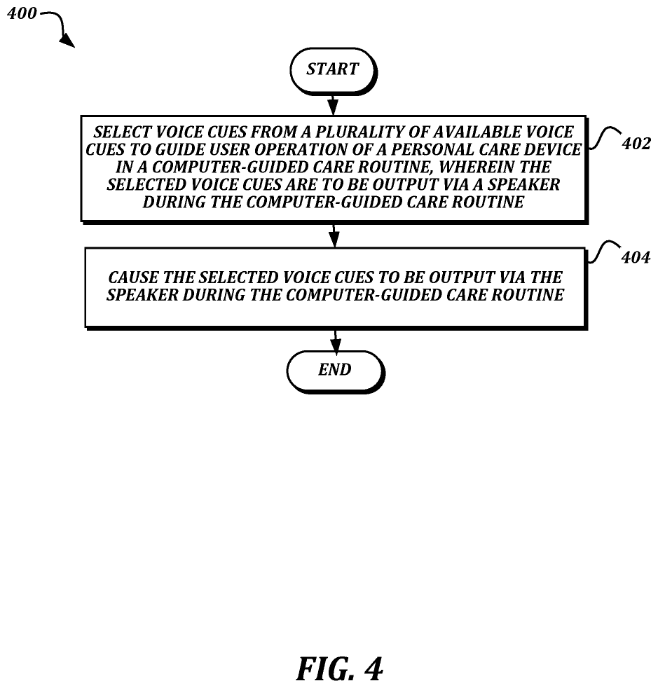

FIG. 4 is a flowchart that illustrates an example embodiment of a method of selecting voice cues to guide user operation of a personal care device (e.g., a hair dryer, a hair styling iron, a phototherapy device, or a powered skin brush), according to various aspects of the present disclosure. As illustrated, the method 400 is implemented by a computer system. The method 400 may be implemented by a server computer system including features of the remote computer system 110, by a personal care device 102, or by some other computing device or system.

From a start block, the method 400 proceeds to block 402, where the computer system selects voice cues from a plurality of available voice cues to guide user operation of a personal care device in a computer-guided care routine. The selected voice cues are to be output via a speaker during the computer-guided care routine. In an embodiment, the selection of voice cues is performed by a networked computing device in communication with the personal care device. In another embodiment, the selection of voice cues is performed by the personal care device itself. In such an embodiment, the voice cues available for selection are stored in or otherwise accessible by the personal care device. The method 400 proceeds to step 404, where the computer system causes the selected voice cues to be output via the speaker during the computer-guided care routine. In an embodiment, the speaker is integrated in the personal care device. In an embodiment, the step of causing the selected voice cues to be output comprises transmitting instructions to output the selected voice cues from the networked computing device to the personal care device.

In an embodiment, the step of selecting the voice cues includes activating a networked computing device in communication with the personal care device to generate one or more voice cues via the HMI that sequence in concert with a computer-guided care routine stored in memory. In another embodiment, the step of selecting the voice cues includes automatically activating one or more voice cues stored at least on a memory device forming part of the personal care device responsive to receiving one or more inputs indicative of a computer-guided care routine. The computer-guided care routine may be controlled by, e.g., the care routine guiding engine 316 of the personal care device 102.

In an embodiment, the computer-guided care routine comprises a plurality of stages, and the step of selecting the voice cues comprises selecting one or more voice cues for each of the stages. In an embodiment, the step of selecting is based on one or more selection criteria such as characteristics of the personal care device, previous outcomes, user preferences or behaviors, time of day, environmental conditions, day of week, day of year, or other selection criteria, or a combination thereof.

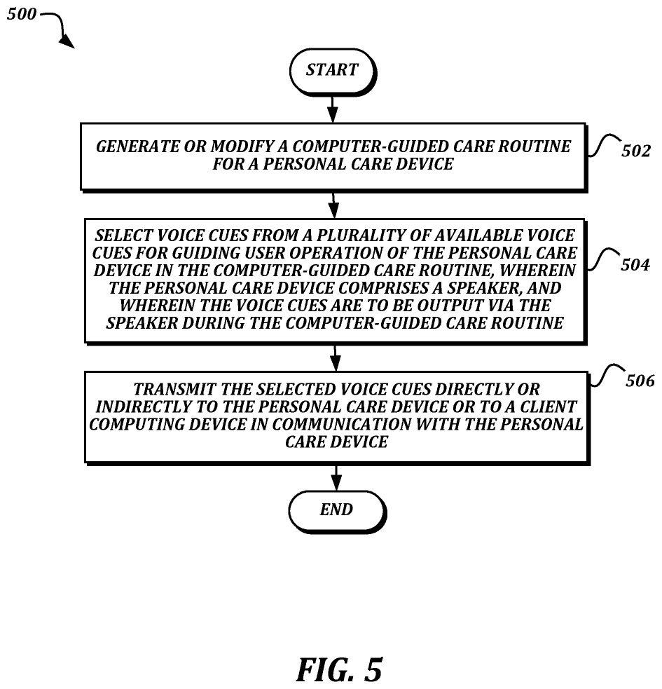

FIG. 5 is a flowchart that illustrates an example embodiment of a method of generating or modifying a computer-guided care routine and selecting voice cues to guide user operation of a personal care device in the care routine, according to various aspects of the present disclosure. As illustrated, the method 500 is implemented by a computer system such as a server computer system including features of the remote computer system 110, or by some other computing device or system.

From a start block, the method 500 proceeds to block 502, where the computer system generates or modifies a computer-guided care routine for a personal care device. The method 500 proceeds to block 504, where the computer system selects voice cues from a plurality of available voice cues for guiding user operation of the personal care device in the computer-guided care routine. The personal care device comprises a speaker, and the voice cues are to be output via the speaker during the computer-guided care routine. In an embodiment, the computer-guided care routine comprises one or more stages, and the step of selecting comprises selecting one or more voice cues for each of the stages. In an embodiment, the step of selecting the voice cues is based on one or more selection criteria comprising characteristics of the personal care device, previous outcomes, user preferences or behaviors, time of day, environmental conditions, day of week, day of year, or other criteria, or a combination thereof. In an embodiment, the step of generating or modifying the computer-guided care routine is also based on one or more criteria such as characteristics of the personal care device, previous outcomes, user preferences or behaviors, time of day, environmental conditions, day of week, day of year, or other criteria, or a combination thereof. The method 500 proceeds to block 506, where the computer system transmits the selected voice cues directly or indirectly to the personal care device or to a client computing device (e.g., a smartphone or tablet computer) in communication with the personal care device.

FIG. 6 is a block diagram that illustrates aspects of an exemplary computing device 600 appropriate for use with embodiments of the present disclosure. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 600 may be any one of any number of currently available or yet to be developed devices.

In its most basic configuration, the computing device 600 includes at least one processor 602 and a system memory 604 connected by a communication bus 606. Depending on the exact configuration and type of device, the system memory 604 may be volatile or nonvolatile memory, such as read only memory (“ROM”), random access memory (“RAM”), EEPROM, flash memory, or similar memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, LTE, 5G, WiMAX, Bluetooth, and/or the like.

In the exemplary embodiment depicted in FIG. 6, the computing device 600 also includes a storage medium 608. However, services may be accessed using a computing device that does not include means for persisting data to a local storage medium. Therefore, the storage medium 608 depicted in FIG. 6 is represented with a dashed line to indicate that the storage medium 608 is optional. In any event, the storage medium 608 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 604 and storage medium 608 depicted in FIG. 6 are merely examples of computer-readable media. In an embodiment, computer-readable media are used to store data for use by programs.

Suitable implementations of computing devices that include a processor 602, system memory 604, communication bus 606, storage medium 608, and network interface 610 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, USB, or other suitable connections protocols using wireless or physical connections. Similarly, the computing device 600 may also include output devices such as a display, speakers, printer, etc. Since these devices are well known in the art, they are not illustrated or described further herein.

### Extensions and Alternatives

Many alternatives to the systems and devices described herein are possible. For example, individual modules or subsystems may be separated into additional modules or subsystems or combined into fewer modules or subsystems. As another example, modules or subsystems may be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein may be modified to accommodate different hardware components, combinations, or arrangements. Further, although some examples in the present disclosure include descriptions of specific usage scenarios, techniques and tools described herein may be modified to accommodate different usage scenarios. Functionality that is described as being implemented in software may instead be implemented in hardware, or vice versa.

Many alternatives to the techniques described herein are possible. For example, processing stages in the various techniques may be separated into additional stages or combined into fewer stages. As another example, processing stages in the various techniques may be omitted or supplemented with other techniques or processing stages. As another example, processing stages that are described as occurring in a particular order may instead occur in a different order. As another example, processing stages that are described as being performed in a series of steps may instead be handled in a parallel fashion, with multiple modules or software processes concurrently handling one or more of the illustrated processing stages.

While illustrative embodiments have been illustrated and described, it will be appreciated that various changes can be made therein without departing from the spirit and scope of the invention.

The embodiments of the invention in which an exclusive property or privilege is claimed are defined as follows:

1. A personal care device, comprising:
at least one treatment application unit configured to apply a treatment to user;
a human-machine interface (HMI) comprising a speaker; and
a personal care unit operably coupled to the HMI and to the at least one treatment application unit, the personal care unit including
circuitry for presenting voice cues via the HMI in a computer-guided care routine to guide user operation of a personal care device, and
circuitry for controlling the at least one treatment application unit.

2. The personal care device of claim 1, wherein the circuitry for presenting voice cues via the HMI includes circuitry for generating a random selection from a set of voice cues stored in memory.

3. The personal care device of claim 1, wherein the circuitry for presenting voice cues via the HMI includes computational circuitry including one or more processors operably connected to a speaker, and configured to enable one or voice cues via the HMI that sequence in concert with a computer-guided care routine stored in memory.

4. The personal care device of claim 1, wherein the personal care device comprises a hair dryer, a hair styling iron, a phototherapy device, or a powered skincare device.

5. The personal care device of claim 1, wherein the personal care device comprises a powered skin brush, and wherein the treatment application device comprises a brush head.

6. The personal care device of claim 1, further comprising:
a network interface;
circuitry for receiving signals from a networked computing device via the network interface; and
circuitry for transmitting signals to the networked computing device via the network interface.

7. The personal care device of claim 6, wherein the signals received from the networked computing device comprise the voice cues.

8. The personal care device of claim 6, wherein the networked computing device comprises a client computing device.

9. The personal care device of claim 6 further comprising:
a microphone; and
circuitry for processing audio input received via the microphone.

10. The personal care device of claim 6, wherein the networked computing device comprises a smart speaker in communication with an external voice services system.

11. A computer-implemented method, comprising:
selecting voice cues from a plurality of available voice cues to guide user operation of a personal care device in a computer-guided care routine, wherein the selected voice cues are to be output via a speaker during the computer-guided care routine; and
causing the selected voice cues to be output via the speaker during the computer-guided care routine.

12. The method of claim 11 wherein selecting voice cues from the plurality of available voice cues to guide user operation of the personal care device in the computer-guided care routine includes activating a networked computing device in communication with the personal care device to generate one or more voice cues via the HMI that sequence in concert with a computer-guided care routine stored in memory.

13. The method of claim 11 wherein causing the selected voice cues to be output includes transmitting instructions to output the selected voice cues from a networked computing device to the personal care device.

14. The method of claim 11 wherein selecting voice cues from the plurality of available voice cues to guide user operation of the personal care device in the computer-guided care routine includes automatically activating one or more voice cues stored at least on a memory device forming part of the personal care device responsive to receiving one or more inputs indicative of a computer-guided care routine.

15. The method of claim 11, wherein selecting voice cues from the plurality of available voice cues to guide user operation of the personal care device in the computer-guided care routine includes selecting one or more voice cues for each of a plurality of stages associated with a computer-guided care routine.

16. The method of claim 11, wherein selecting voice cues from the plurality of available voice cues to guide user operation of the personal care device in the computer-guided care routine includes selecting based on one or more selection criteria comprising characteristics of the personal care device, previous outcomes, user preferences or behaviors, time of day, environmental conditions, day of week, day of year, or a combination thereof.

17. A computer-implemented method, comprising:
by a server computer, generating or modifying a computer-guided care routine for a personal care device;
by the server computer, selecting voice cues from a plurality of available voice cues for guiding user operation of the personal care device in the computer-guided care routine, wherein the personal care device comprises a speaker, and wherein the voice cues are to be output via the speaker during the computer-guided care routine; and
by the server computer, transmitting the selected voice cues directly or indirectly to the personal care device or to a client computing device in communication with the personal care device.

18. The method of claim 17, wherein the computer-guided care routine comprises one or more stages, and wherein the selecting comprises selecting one or more voice cues for each of the stages.

19. The method of claim 17, wherein the step of selecting the voice cues is based on one or more selection criteria comprising characteristics of the personal care device, previous outcomes, user preferences or behaviors, time of day, environmental conditions, day of week, day of year, or a combination thereof.

20. The method of claim 17, wherein the step of generating or modifying the computer-guided care routine is based on one or more criteria comprising characteristics of the personal care device, previous outcomes, user preferences or behaviors, time of day, environmental conditions, day of week, day of year, or a combination thereof.
